(19) United States
(12) Patent Application Publication
(10) Pub. No.: US 2024/0239352 A1
(43) Pub. Date: Jul. 18, 2024

(54) SYSTEMS AND METHODS FOR DETECTING SPEEDING VIOLATIONS

(71) Applicant: Ford Global Technologies, LLC, Dearborn, MI (US)

(72) Inventors: Stuart C. Salter, White Lake, MI (US); Brendan Diamond, Grosse Pointe, MI (US); Paul Kenneth Dellock, Northville, MI (US); Christopher Charles Hunt, Livonia, MI (US); Doug H. Randlett, Metamora, MI (US); John Robert Van Wiemeersch, Novi, MI (US)

(73) Assignee: Ford Global Technologies, LLC, Dearborn, MI (US)

(21) Appl. No.: 18/153,816

(22) Filed: Jan. 12, 2023

(51) Int. Cl. B60W 40/105; G06V 20/58

(52) U.S. Cl. CPC B60W 40/105; G06V 20/58; B60W 2420/42; B60W 2420/52

(57) ABSTRACT

The disclosure is generally directed to systems and methods for detecting and responding to speeding violations. An example method executed by a processor in a first vehicle (a law-enforcement vehicle, for example) can include receiving, from a vehicle speed detection system, a speed measurement associated with a second vehicle. The processor may determine that the speed of the second vehicle exceeds a threshold speed and may operate a camera to capture an image of the second vehicle. The image may be evaluated for determining at least one identifying feature of the second vehicle. A record may then be generated. The record can include the speed measurement, the image, and the first identifying feature. In some cases, the record may be transmitted to another law-enforcement vehicle for pursuing the second vehicle and/or to an Internet-of-Things (IoT) roadside unit for tracking the second vehicle.

### BACKGROUND

Traffic police typically face various types of challenges when dealing with speeding violations. Among these challenges is a need to quickly and accurately identify a speeding vehicle and take responsive action. It is desirable to provide systems and methods that assist traffic police and/or other law enforcement officers perform such tasks.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an example vehicle that includes a speeding violation responder system in accordance with an embodiment of the disclosure.

FIG. 2 shows a first example scenario where a speeding violation responder system may be used in accordance with an embodiment of the disclosure.

FIG. 3 shows a second example scenario where a speeding violation responder system may be used in accordance with an embodiment of the disclosure.

FIG. 4 shows a third example scenario where two records associated with a speeding violation are generated in accordance with an embodiment of the disclosure.

FIG. 5 shows a flowchart of a method to implement a speeding violation detection and response procedure in accordance with an embodiment of the disclosure.

FIG. 6 shows some functional components that may be included in a vehicle that includes a speeding violation responder system in accordance with an embodiment of the disclosure.

### DETAILED DESCRIPTION

### Overview

In terms of a general overview, embodiments described in this disclosure are generally directed to systems and methods for detecting and responding to speeding violations. An example method executed by a processor of a speeding violation responder system in a first vehicle such as, for example, a law-enforcement vehicle, can include receiving, from a vehicle speed detection system of the first vehicle, a speed measurement associated with a second vehicle. The processor may determine that a speed of the second vehicle exceeds a posted speed limit. The processor may then activate and receive from an image capture system of the first vehicle, an image that includes the second vehicle. At least one identifying feature of the second vehicle may be determined based on evaluating the image and a record may be generated. Identifying features can include, for example, a registration plate, a paint color, a damage (dent, missing part, etc.), a sticker, and an accessory (ski rack, bicycle rack, spoiler etc.). The record can include the speed measurement, the image, and the first identifying feature of the second vehicle. In an example scenario, the record may be transmitted to another law-enforcement vehicle for taking action upon the second vehicle. In another example scenario, the record may be transmitted to an Internet-of-Things (IoT) roadside unit for tracking the second vehicle.

### Illustrative Embodiments

The disclosure will be described more fully hereinafter with reference to the accompanying drawings, in which example embodiments of the disclosure are shown. This disclosure may however, be embodied in many different forms and should not be construed as limited to the example embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described example embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and phrases are used herein solely for convenience and such words and terms should be interpreted as referring to various objects and actions that are generally understood in various forms and equivalencies by persons of ordinary skill in the art. For example, it must be understood that the word “object” as used herein with respect to images encompasses various inanimate objects outside a vehicle (vehicles, traffic lights, traffic signs, etc.) and animate objects (pedestrians, drivers, passengers, etc.). Words such as “image” and “photograph” may be used herein in an interchangeable manner. More particularly, the word “image” as used herein is merely one example of “data” or “information” in accordance with the disclosure. Other forms of data may include sensor signals captured by use of various types of sensors provided in a vehicle (infrared sensors, motion detectors, sonar, radar, images, etc.). The images/photographs referred to herein in accordance with the disclosure may be obtained by use of various types of image capture devices (still camera, digital camera, video camera, smartphone, etc.). The various forms of images/photographs can include still photographs, video clips, real-time video, movies, still frames etc. A still frame is a single static image that may be obtained from a video clip or a video stream. A video clip is generally composed of a set of images that are captured sequentially over a period of time. Thus, a description below with respect to a single image is equally applicable to a video clip for example. The word “vehicle” as used in this disclosure can pertain to any one of various types of vehicles such as, for example, cars, vans, sports utility vehicles, trucks, electric vehicles, gasoline vehicles, and hybrid vehicles. Furthermore, the description provided herein is applicable to various vehicles incorporating various kinds of driving automation such as, for example, the six levels of driving automation that is defined by the Society of Automotive Engineers (SAE) as ranging from Level 0 (fully manual) to Level 5 (fully autonomous).

It must be further understood that the description herein refers to detecting speeding violations, which is merely one example of a traffic violation. Accordingly, the systems and methods described herein are equally applicable to any of various other types of traffic violations including for example, improper lane changes, rash driving, driving with an expired license, driving with no registration, driving under the influence, etc. Thus, in an example scenario, a speeding violation responder system may capture an image in accordance with the disclosure upon detecting a vehicle that is weaving haphazardly (even if traveling below a speed limit). The motion of the vehicle may be indicative of the vehicle being driven by a driver who is under the influence of alcohol.

It must also be understood that words such as “implementation,” “application,” “scenario,” “case,” and “situation” as used herein are an abbreviated version of the phrase “In an example (“implementation,” “application,” “scenario,” “case,” “approach,” and “situation”) in accordance with the disclosure.” It must also be understood that the word “example” as used herein is intended to be non-exclusionary and non-limiting in nature.

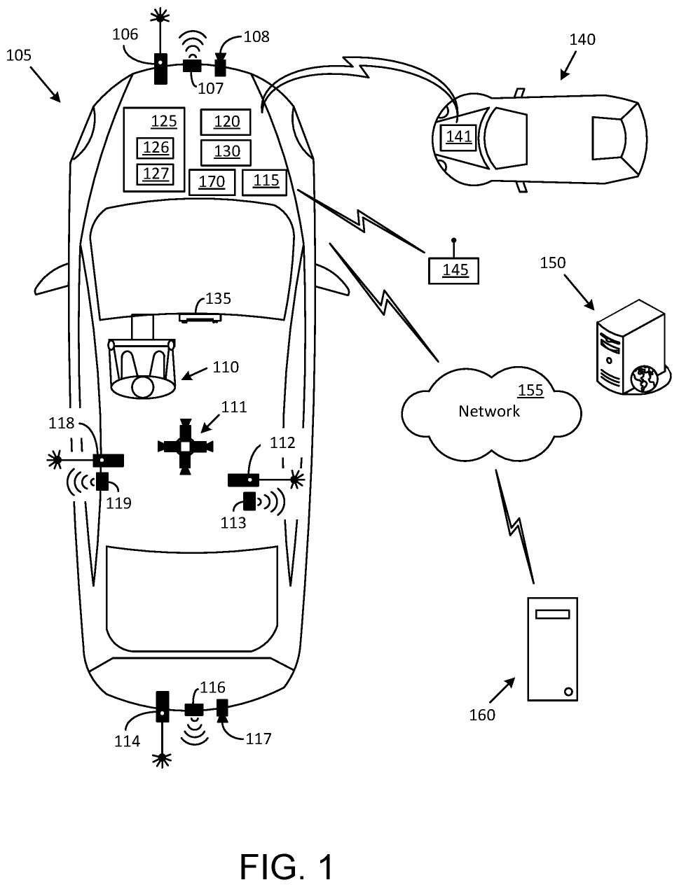

FIG. 1 shows a vehicle 105 that includes a speeding violation responder system 125 in accordance with an embodiment of the disclosure. In an example scenario, the vehicle 105 is a law-enforcement vehicle such as, for example, a police sedan. However, in other scenarios, the vehicle 105 can be any of various types of vehicles operated by various types of agencies. Henceforth, the label “vehicle 105” and “law-enforcement vehicle 105” may be used in an interchangeable manner. The speeding violation responder system 125 can include a processor 126 that is configured to execute computer-executable instructions stored in a memory 127 for performing various operations in accordance with the disclosure. The vehicle 105 may further include components such as, for example, a vehicle controller 130, a communications system 115, an infotainment system 135, a vehicle speed detection system 120, and an image capture system 170.

The vehicle controller 130 may be operated to execute various operations related to the vehicle 105, such as, for example, controlling engine operations (fuel injection, speed control, emissions control, braking, etc.), managing climate controls (air conditioning, heating etc.), activating airbags, and issuing alerts (check engine light, bulb issues, low tire pressure, etc.), and also for executing various operations in accordance with disclosure.

In the illustrated example scenario, the vehicle 105 is a driver-operated vehicle and the driver of the vehicle 105 can be, for example, a law-enforcement officer 110. In other scenarios, the vehicle 105 can be driven by various other types of individuals, such as, for example, an emergency services responder or a private security officer. The vehicle controller 130 responds to actions performed by the law-enforcement officer 110 (such as, for example, reducing the speed of the vehicle 105 when the law-enforcement officer 110 executes a braking operation, moving the vehicle 105 at a cruising speed when the law-enforcement officer 110 applies cruise control, and selecting an appropriate gear when the law-enforcement officer 110 steps on the accelerator).

In another example scenario, the vehicle 105 is an autonomous vehicle and the vehicle controller 130 performs some or all of various operations that may replicate those performed by the law-enforcement officer 110. More particularly, the vehicle controller 130 of the autonomous vehicle can be configured to autonomously perform various operations associated with detecting speeding violations in accordance with the disclosure. Detecting speeding violations can include operations such as, for example, operating the vehicle speed detection system 120 for determining a speed of one or more other vehicles by, operating the image capture system 170 for capturing one or more images of one or more vehicles that may be involved in speeding violations, and generating a record of the speeding violation.

The infotainment system 135 may include a combination of various entertainment items (such as a radio, streaming audio solutions, etc., and USB access ports for digital audio devices). The infotainment system 135 may also include other types of items, such as, for example, a navigation system and a graphical user interface (GUI) that is displayed on a display screen. The law-enforcement officer 110 may use the GUI for interacting with the speeding violation responder system 125 and for executing various operations in accordance with the disclosure. Some example operations can include transmitting a request to another law-enforcement officer in another vehicle, for performing one or more actions with respect to a vehicle that may be involved in a speeding violation.

The vehicle speed detection system 120 can include various types of speed detectors that are configured to obtain speed measurements of various vehicles that may be traveling on a highway, for example. More particularly, in accordance with an embodiment of the disclosure, the vehicle speed detection system 120 can include a radar device and a light detection and ranging (LIDAR) device. The radar device may be operated to detect a group of vehicles in which one or more vehicles are traveling over a posted speed limit. The speeding violation responder system 125 may use information such as, for example, speed measurements provided by the radar device, to obtain a “coarse” indication that at least a first vehicle in the group of vehicles is traveling over the posted speed limit. The LIDAR device, which uses a light beam for obtaining a speed measurement may then be operated in order to establish a “narrow” aim upon the first vehicle for determining the speed of the first vehicle. The measurement provided by the LIDAR device may thus allow the speeding violation responder system 125 to distinguish between the first vehicle that is traveling over the posted speed limit and a second vehicle that is traveling close to the first vehicle and may or may not, be traveling over the posted speed limit.

The various devices of the vehicle speed detection system 120 may be located at various places upon the vehicle 105 and communicatively coupled to the speeding violation responder system 125 by use of wireless and/or wired connections. For example, a radar device 107 may be mounted upon a front portion of the vehicle 105 (for example, on a front bumper, behind a grille, on the front windshield, etc.) and configured for capturing vehicle speed data of vehicles moving in front of the vehicle 105. A LIDAR device 106 may be mounted beside the radar device 107 and configured for capturing vehicle speed data of the vehicles moving in front of the vehicle 105.

A radar device 116 may be mounted upon a rear portion of the vehicle 105 (for example, on a rear bumper, on a trunk, on a license plate etc.) and configured for capturing vehicle speed data of vehicles moving behind the vehicle 105. A LIDAR device 114 may be mounted beside the radar device 116 and configured for capturing vehicle speed data of the vehicles moving behind of the vehicle 105.

A radar device 119 may be mounted upon a roof of the vehicle 105 and configured for capturing vehicle speed data of vehicles that may be moving on a driver side of the vehicle 105 along a generally parallel path or an angular (<90 degrees) path with respect to a longitudinal axis of the vehicle 105. A LIDAR device 118 may be mounted beside the radar device 113 and configured for capturing vehicle speed data of the vehicles moving on the driver side of the vehicle 105.

A radar device 113 may be mounted upon the roof of the vehicle 105 and configured for capturing vehicle speed data of vehicles that may be moving on a passenger side of the vehicle 105 along a generally parallel path or an angular (<90 degrees) path with respect to the longitudinal axis of the vehicle 105. A LIDAR device 112 may be mounted beside the radar device 113 and configured for capturing vehicle speed data of the vehicles moving on the passenger side of the vehicle 105.

Other vehicle speed detection devices (not shown) that are operable by the speeding violation responder system 125 can include sensors and detectors such as, for example, infrared detectors, motion detectors, distance sensors, proximity sensors, and audio sensors. The information obtained by operating the various vehicle speed detection devices can be used by the speeding violation responder system 125 and/or by other computing devices that are communicatively coupled to the speeding violation responder system 125 for various purposes in accordance with the disclosure.

The image capture system 170 can include one or more cameras. The cameras can be any of various types of image capture devices such as, for example, a digital camera that captures a still image, a video camera that captures a video clip, a video camera that captures real-time video, and/or an infrared camera. Each of the cameras may be mounted at any of various locations on the vehicle 105. In the illustrated implementation, each of the camera 111, the camera 108, and the camera 117 is mounted upon a body portion of the vehicle 105 in a manner that allows the cameras to be operated for capturing images of objects located outside the vehicle 105.

More particularly, in the illustrated example, the camera 111 is an image capture device that is mounted upon the roof the vehicle 105. The camera 111 is configured to provide a 360-degree field of view for capturing images of objects located around the outside of the vehicle 105. The images are conveyed to the speeding violation responder system 125 for executing various operations in accordance with the disclosure.

The camera 108 may be mounted upon a front portion of the vehicle 105 (for example, on a front bumper, behind a grille, on the front windshield, etc.) and configured for capturing images of objects located in front of the vehicle 105. The camera 117 may be mounted upon a rear portion of the vehicle 105 (for example, on a rear bumper, on a trunk, on a license plate etc.) and configured for capturing images of objects located behind the vehicle 105. Images captured by the camera 108 and the camera 117 may be conveyed to the speeding violation responder system 125 for performing various actions in accordance with the disclosure such as, for example, to determine one or more identifying features of a vehicle. Some example identifying features can be a registration plate of the vehicle, a paint color of the vehicle, a damaged part of the vehicle (dent, missing part, etc.) and an accessory (ski rack, bicycle rack, spoiler etc.).

When the vehicle 105 is an autonomous vehicle, images captured by the camera 111, the camera 108 and/or the camera 117 may be conveyed to the vehicle controller 130 to enable the vehicle controller 130 to autonomously control the movement of the vehicle 105 (navigation, object avoidance, etc.).

In an example implementation of the disclosure, one or more of the cameras can be controlled by the law-enforcement officer 110 for capturing images that are conveyed by the cameras to the speeding violation responder system 125 for various purposes in accordance with the disclosure. In another example implementation, one or more of the cameras can be controlled by the speeding violation responder system 125 either in cooperation with the law-enforcement officer 110 (when present) or independently such as, for example, when the vehicle 105 is an autonomous vehicle or when the image capture process is automated. The captured images can be used for various purposes in accordance with the disclosure.

The communication system 115 of the vehicle 105 is configured to wirelessly communicate with various devices such as, for example, a computer 160, a cloud computer 150, an Internet-of-Things (IoT) roadside unit 145, and a speeding violation responder system 141 provided in a vehicle 140. In an example scenario, the vehicle 140 is another law-enforcement vehicle.

The wireless communications may be carried out via device-to-device communications and/or via a network 155. The device-to-device communications may involve, for example, vehicle-to-vehicle (V2V) communications that may be used by the communication system 115 of the vehicle 105 to communicate with the communication system 141 of the vehicle 140, and vehicle-to-infrastructure (V2I) communications that may be used by the communication system 115 of the vehicle 105 to communicate with the IoT roadside unit 145.

The network 155 may include any one, or a combination of networks, such as, for example, a local area network (LAN), a wide area network (WAN), a telephone network, a cellular network, a cable network, a wireless network, and/or private/public networks such as the Internet. At least one portion of the network 155 includes a wireless communication link such as, for example, a cellular communication link, a WiFi communications link, an ultra-wideband (UWB) communication link, and a Bluetooth® communication link.

The computer 160 can be any of various types of computers such as, for example, a server computer, a client device, a personal computer, and/or a distributed computer (multiple computers operating in cooperation with each other as a single computing entity). In an example implementation, the computer 160 is a server computer configured to store traffic-related information of various vehicles including records related to traffic violations. Records related to traffic violations can include, for example, moving violations (speeding tickets, reckless driving, improper lane changing, driving without lights, etc.) and other violations (damaged tail lights, expired vehicle registration, driving license suspension, etc.).

The cloud computer 150 may be used either independently or together with the computer 160 to store records related to traffic violations.

The IoT roadside unit 145 can be configured to execute various functions such as, for example, to provide tracking functions and/or to relay communications transmitted by the speeding violation responder system 125 to devices such as another IoT roadside unit (not shown) or the computer 160. An example tracking function may involve the operation of a camera (not shown) of the IoT roadside unit 145 to capture an image (or real-time video) of a vehicle and to track a movement of the vehicle. Identifying a vehicle for purposes of carrying out a tracking function may be based on a record of the vehicle that may be transmitted by the speeding violation responder system 125 to the IoT roadside unit 145.

The speeding violation responder system 141 provided in the vehicle 140 may be substantially identical to the speeding violation responder system 125 provided in the vehicle 105 and may be configured to perform functions that are substantially identical to functions performed by the speeding violation responder system 125.

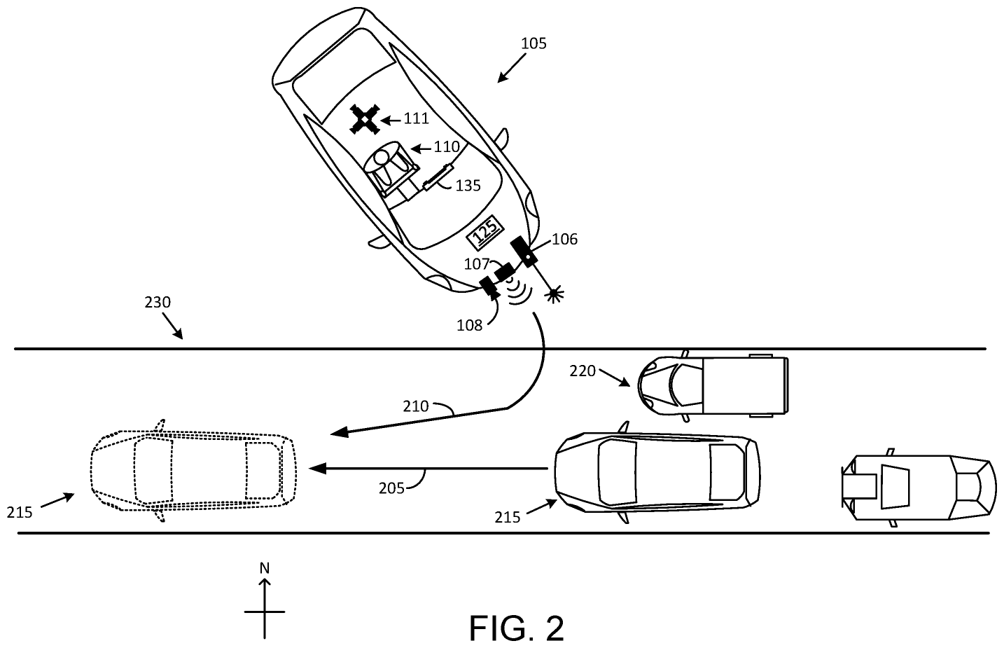

FIG. 2 shows a first example scenario where the speeding violation responder system 125 may be used in accordance with an embodiment of the disclosure. In this example scenario, the vehicle 105 is parked at an angle with respect to a road 230. A front portion of the vehicle 105 faces the road 230 and some devices of the vehicle speed detection system 120 (such as, for example, the radar device 107 and the LIDAR device 106) and of the image capture system 170 (such as, for example, the camera 108 and/or the camera 111) may be found suitable for monitoring speeding violations. In other scenarios, where the vehicle 105 is parked with a different orientation, various other devices of the vehicle speed detection system 120 and the image capture system 170 may be used for monitoring speeding violations.

In the illustrated example scenario, a group of vehicles is traveling west on the road 230. One or more of the vehicles in the group of vehicles may be traveling over a posted speed limit.

The radar device 107 may be first activated by the speeding violation responder system 125 for monitoring the group of vehicles to detect one or more vehicles that may be traveling over a first threshold speed. The first threshold speed may be equal to, or different than, the posted speed limit. In an example implementation, the first threshold speed may be selected by the law-enforcement officer 110 and entered into the speeding violation responder system 125 (via the GUI of the infotainment system 135, for example). The law-enforcement officer 110 may for example, decide to select the first threshold speed based on a margin value above the posted speed limit applicable to the road 230.

In an example scenario, the law-enforcement officer 110 may for example, decide to select the first threshold speed to be a percentage value over the posted speed limit (20% over the posted speed limit, for example) or an absolute value above the posted speed limit (10 mph over the posted speed limit, for example).

The first threshold speed may be used to alert the law-enforcement officer 110 of a speeding condition on the road 230. The law-enforcement officer 110 may use the alert to perform any of various actions such as, for example, to issue a visual alert (turning on a red-white-blue light on the roof the vehicle 105, for example) and/or an audible alert (activate a siren, for example) to alert the vehicles traveling on the road 230 to slow down. The law-enforcement officer 110 may or may not, at this time, opt to pursue any of the vehicles traveling on the road 230.

In an example situation, the radar device 107 may provide a trigger signal to alert the law-enforcement officer 110 of a speeding condition on the road 230. The trigger signal may fail to provide adequate information for the speeding violation responder system 125 to unambiguously identify a specific vehicle among the group of vehicles that may be exceeding the posted speed limit by a large margin (for example, 40% over the posted speed limit). For example, the trigger signal may indicate an average speed of movement of two or more vehicles such as, for example, an average speed of movement of a vehicle 215 and a vehicle 220 that is moving beside the vehicle 215. The radar device 107 may emit a radar signal having a broad radiation pattern that may reflect off a front portion of the vehicle 215 and at least a portion of the vehicle 220. The speeding violation responder system 125 may be unable to identify based on the speed measurement provided by the radar device 107 whether only one, or both, of the vehicle 215 and the vehicle 220 are exceeding the posted speed limit by a large margin.

Accordingly, in accordance with an embodiment of the disclosure, the speeding violation responder system 125 may prompt the law-enforcement officer 110 to provide a visual identification of a specific vehicle that appears to be exceeding the posted speed limit. The prompt may be provided in the form of a notification displayed on the GUI of the infotainment system 135 and/or as an audio signal (a beep through a speaker of the infotainment system 135, for example). The law-enforcement officer 110 may respond to the prompt by providing an indication to the speeding violation responder system 125 that the vehicle 215 is a target vehicle that appears to be exceeding the posted speed limit based on a visual examination of the group of vehicles.

Based on the input provided by the law-enforcement officer 110, the speeding violation responder system 125 may activate the LIDAR device 106 and configure the LIDAR device 106 to target, and to measure, a speed of movement of the vehicle 215. The speeding violation responder system 125 may compare a speed measurement obtained from the LIDAR device 106 against a second threshold speed. In one implementation, the second threshold speed may be set equal to the first threshold speed. In another implementation, the second threshold speed may be set different than the first threshold speed such as, for example, above the first threshold speed (for example, 40% over a posted speed limit). The speeding violation responder system 125 may display (via the GUI of the infotainment system 135, for example) a result of comparing the speed measurement obtained from the LIDAR device 106 against the second threshold speed and/or a speed measurement associated with the vehicle 215.

The law-enforcement officer 110 may evaluate the displayed information and decide whether to take responsive action. In one case, the law-enforcement officer 110 may provide an indication to the speeding violation responder system 125 of a decision to pursue the vehicle 215 for purposes of issuing a citation or a warning. In this case, the speeding violation responder system 125 may automatically transmit a warning to the vehicle computer (not shown) and/or a speeding violation responder system (not shown) of the vehicle 220 to slow down and allow the vehicle 105 to enter the road 230 for pursuing the vehicle 215 along a movement path 210. The warning may be conveyed via V2V communications, for example. The vehicle 215 may have continued to travel along a movement path 205.

In accordance with another embodiment of the disclosure, the speeding violation responder system 125 may transmit a signal to activate the camera 108 for capturing an image that includes at least a front portion of the vehicle 215 and at least a portion of the vehicle 220. The captured image may be evaluated by the speeding violation responder system 125 (together with the speed measurement provided by the radar device 107) for determining that at least two vehicles (the vehicle 215 and the vehicle 220) appear to be exceeding the posted speed limit by a large margin. In some cases, techniques such as artificial intelligence and/or machine learning may be employed for evaluating the captured image. If both vehicles are determined to be exceeding the posted speed limit, the speeding violation responder system 125 may activate the LIDAR device 106 to identify which of the two vehicles is moving faster. In this case, the speeding violation responder system 125 may configure the LIDAR device 106 to obtain a speed measurement of the vehicle 215 exclusively and further configure the LIDAR device 106 to obtain a speed measurement of the vehicle 220 exclusively.

In an example scenario, the speeding violation responder system 125 may determine that the vehicle 215 is traveling over the posted speed limit by a large margin and/or is traveling faster than the vehicle 220. The speeding violation responder system 125 may display upon the GUI of the infotainment system 135 one or both the speed measurements of the vehicle 215 and/or the vehicle 220.

The law-enforcement officer 110 may evaluate the displayed information and decide whether to take responsive action in the form of a pursuit. In one case, the law-enforcement officer 110 may provide an indication to the speeding violation responder system 125 of a decision to pursue the vehicle 215 for purposes of issuing a citation or a warning. In this case, the speeding violation responder system 125 may automatically transmit a warning to the vehicle controller (not shown) and/or a speeding violation responder system (not shown) of the vehicle 220 to slow down and allow the vehicle 105 to enter the road 230 for pursuing the vehicle 215 along a movement path 210. The warning may be conveyed via V2V communications, for example. The vehicle 215 may have traveled along a movement path 205 ahead of the vehicle 105.

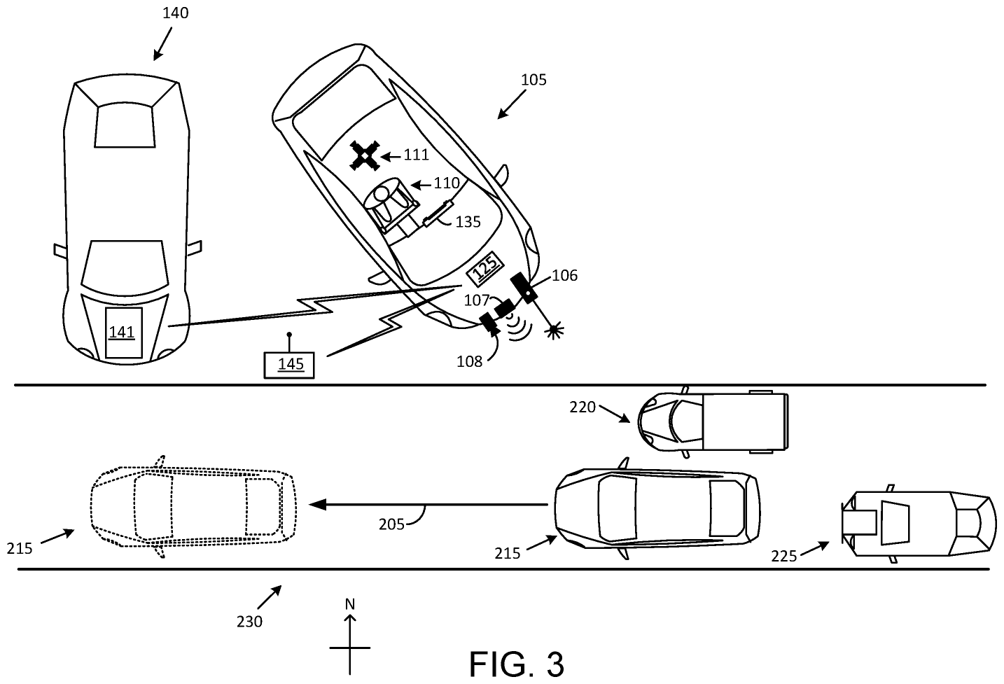

FIG. 3 shows a second example scenario where the speeding violation responder system 125 may be used in accordance with an embodiment of the disclosure. The description provided above with reference to the first example scenario (shown in FIG. 2) is applicable up to the point where the speeding violation responder system 125 displays upon the GUI of the infotainment system 135, one or both the speed measurements of the vehicle 215 and/or the vehicle 220. In the first example scenario described above, the law-enforcement officer 110 evaluates the displayed information and decides to engage in a pursuit of the vehicle 215.

In the second example scenario, the law-enforcement officer 110 may evaluate the displayed information and decide not to pursue the vehicle 215 for one or more reasons such as, for example, due to high traffic congestion on the road 230, a high speed of travel of the vehicle 215. In this second scenario, the law-enforcement officer 110 may provide an indication to the speeding violation responder system 125 of a decision not to pursue the vehicle 215 and may further make a request to the speeding violation responder system 125 to take action in the matter.

In this case, the speeding violation responder system 125 may automatically transmit a signal to activate the camera 108 for capturing an image that includes at least a portion of the vehicle 215 that is in a field of view of the camera 108 at a first instant in time and/or an entirety of the vehicle 215 that is in a field of view of the camera 108 at a second instant in time when the vehicle 215 has traveled further down the road 230. The speeding violation responder system 125 may evaluate the captured image to determine one or more identifying features of the vehicle 215 that may be unique to the vehicle 215 and/or may be used for identifying the vehicle 215 when the vehicle 215 is moving along with a number of vehicles. Identifying features of the vehicle 215 can include, for example, a make, a model, a year of manufacture, a registration plate, a paint color, a damage (dent, missing part, etc.), a sticker, and an accessory (ski rack, bicycle rack, spoiler etc.). In an example implementation, the speeding violation responder system 125 may display the image on a display screen of the infotainment system 135 and seek the assistance of the law-enforcement officer 110 to determine one or more identifying features of the vehicle 215.

In an example embodiment, the speeding violation responder system 125 may generate a record that can include a speed measurement associated with the vehicle 215, the image of the vehicle 215 that was captured by the camera 108, and one or more identifying features of the vehicle 215 determined by the speeding violation responder system 125. In some cases, the record may include input provided by the law-enforcement officer 110 via the GUI of the infotainment system 135 such as, for example, one or more identifying features of the vehicle 215. The record may further include a first timestamp when the speed measurement was captured by the LIDAR device 106, a second timestamp when the image of the vehicle 215 was captured by the camera 108, and/or location information where the speeding violation occurred and data associated with the vehicle 215 (speed, image, etc.) was obtained.

The record may be transmitted, for example, to the computer 160 which can be a server computer configured to store traffic-related information of various vehicles and records related to traffic violations. The information stored in the computer 160 may be used by a law-enforcement agency as court documents, if judicial action is taken in court against a driver of the vehicle 215.

In an example scenario, the speeding violation responder system 125 may wirelessly transmit at least some of the record (such as, for example, the speed measurement of the vehicle 215, the image of the vehicle 215, and identifying information of the vehicle 215) to the speeding violation responder system of another law-enforcement vehicle (such as, for example, to the speeding violation responder system 141 of the vehicle 140). In an example scenario, real-time information associated with the vehicle 215 may be transmitted to the speeding violation responder system 141 of the vehicle 140. The real-time information may be obtained via a video capture operation executed by the camera 108 under control of the speeding violation responder system 125.

The speeding violation responder system 125 may further transmit a request via the speeding violation responder system 141 of the law-enforcement vehicle 140 to a law-enforcement officer in the law-enforcement vehicle 140 for taking action with respect to the vehicle 215 as it travels down the road and away from the vehicle 105. Some example actions that may be taken against the vehicle 215 can include, for example, a pursuit of the vehicle 215 by the law-enforcement vehicle 140, a stopping of the vehicle 215 by the law-enforcement officer in the law-enforcement vehicle 140, and/or issuance of a speeding ticket to a driver of the vehicle 215 by the law-enforcement officer.

In another example scenario, the speeding violation responder system 125 may wirelessly transmit (via V2I communications, for example) at least some of the record (such as, for example, the speed measurement of the vehicle 215, the image of the vehicle 215, and identifying information of the vehicle 215) to the IoT roadside unit 145 together with a request to track a movement of the vehicle 215 as the vehicle 215 moves down the road 230 and away from the vehicle 105. The IoT roadside unit 145 may initiate a tracking procedure that may include image capture of the vehicle 215 by an image capture system of the IoT roadside unit 145. The image capture may include capturing a real-time video of the vehicle 215. In some cases, the tracking procedure may include the use of real time video and/or a video clip provided to the IoT roadside unit 145 by the speeding violation responder system 125 of the vehicle 105. The tracking procedure can include a hand-off procedure where the IoT roadside unit 145 communicates with another IoT roadside unit further down the road 230, a base station, and/or the computer 160. Communications with the computer 160 can include transmission of a record generated by the IoT roadside unit 145 in connection with the tracking procedure of the vehicle 215.

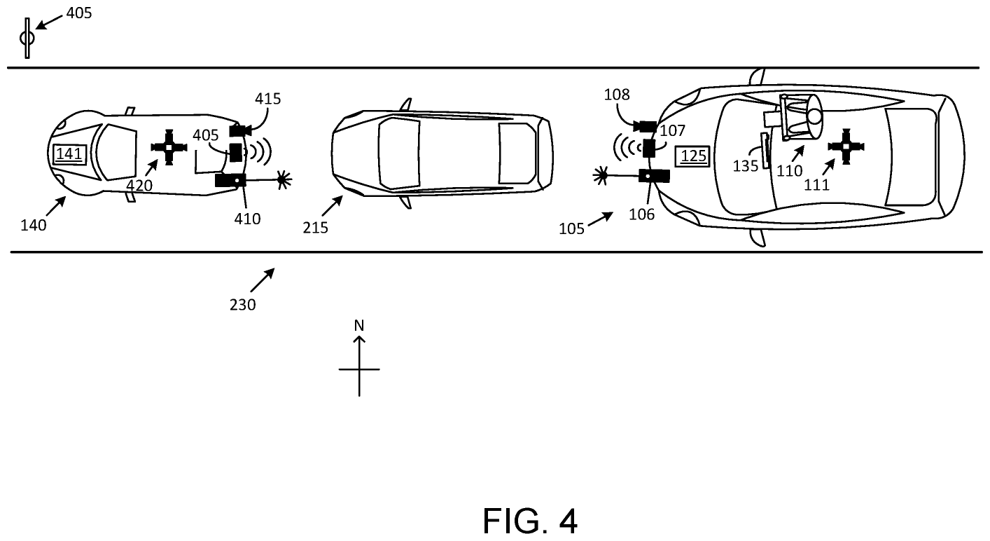

FIG. 4 shows a third example scenario where two records associated with a speeding violation are generated in accordance with an embodiment of the disclosure. The third example scenario can be an operation that takes place after the law-enforcement vehicle 105 engages in a pursuit operation of the vehicle 215 as described above with reference to FIG. 2. In this case, the law-enforcement vehicle 105 communicates with the law-enforcement vehicle 140 that may be stationed further west, to engage in a tandem pursuit arrangement. More particularly, the speeding violation responder system 125 of the law-enforcement vehicle 105 may wirelessly transmit to the speeding violation responder system 141 of the vehicle 140, at least some of the record that is associated with the vehicle 215 (such as, for example, the speed measurement of the vehicle 215, the image of the vehicle 215, and identifying information of the vehicle 215). In an example scenario, real-time information associated with a pursuit of the vehicle 215 by the law-enforcement vehicle 105 may be transmitted to the speeding violation responder system 141 of the vehicle 140. The real-time information may be obtained via a video capture operation executed by the camera 108 under control of the speeding violation responder system 125.

The speeding violation responder system 141 of the vehicle 140 may provide directions to a law-enforcement officer in the law-enforcement vehicle 140 (for example, via a GUI of an infotainment system of the law-enforcement vehicle 140). The instructions may enable the law-enforcement officer in the law-enforcement vehicle 140 to move into position ahead of the vehicle 215 as a part of the tandem pursuit arrangement whereby the vehicle 215 is sandwiched between the law-enforcement vehicle 140 and the law-enforcement vehicle 105.

The tandem pursuit arrangement allows the law-enforcement vehicle 140 and the law-enforcement vehicle 105 to cooperate with each other for performing various operations. One example operation may involve compelling a driver of the vehicle 215 to slow down and to pull over to the side of the road 230. Another example operation may involve obtaining two distinct records of a speeding violation associated with the vehicle 215. The two distinct records can include a first record that the speeding violation responder system 125 of the vehicle 105 may generate and a second record that the speeding violation responder system 141 of the vehicle 140 may generate. The first record may be generated by the speeding violation responder system 125 by use of information obtained from one or more speed detection devices (such as, for example, the radar device 107 and/or the LIDAR device 106) and one or more image capture devices (such as, for example, the camera 108 and/or the camera 111).

The second record may be generated by the speeding violation responder system 141 by use of information obtained from one or more speed detection devices (such as, for example, a radar device 405 and/or a LIDAR device 410 mounted upon a rear portion of the law-enforcement vehicle 140) and images captured by one or more image capture devices (such as, for example, a camera 415 mounted upon a rear portion of the law-enforcement vehicle 140 and/or a camera 420 mounted upon a roof of the law-enforcement vehicle 140).

In an example implementation, the first record generated by the speeding violation responder system 125 and/or the second record generated by the speeding violation responder system 141, can include an image of one or more objects such as, for example, a posted sign that indicates a speed limit applicable to the road 230 at the site of the speeding violation, and/or an object that provides an indication of the location of the vehicle 215 at the time of the speeding violation (a mile marker, a street sign, a distinct building, etc.). The second record may further include one or more timestamps that provide an indication of a time at which the speeding violation occurred.

In an example implementation, the first record generated by the speeding violation responder system 125 and the second record generated by the speeding violation responder system 141 may be wirelessly transmitted to the computer 160 for use by a law-enforcement agency as court documents, if judicial action is taken in court against the driver of the vehicle 215. In an example scenario, the second record may be used to complement, supplement, support, or confirm evidence derived from the first record, and vice-versa.

The tandem pursuit arrangement described above involves both the law-enforcement vehicle 140 and the law-enforcement vehicle 105 traveling in the same direction (westwards) as the vehicle 215. In one case, the tandem pursuit arrangement may support a hand-over arrangement wherein the law-enforcement vehicle 105 may discontinue pursuit of the vehicle 215 such as, for example, upon reaching a boundary line (county line, state line, etc.). The second record generated by the speeding violation responder system 141 of the law-enforcement vehicle 140 may be used in court cases to complement evidence derived from the first record.

In another example scenario in accordance with the disclosure, the law-enforcement vehicle 140 and the law-enforcement vehicle 105 may engage in an opposing arrangement for generating two independent records and/or for pursuing the vehicle 215 that is speeding. More particularly, in this example scenario, the law-enforcement vehicle 140 may be stationed further west of the law-enforcement vehicle 105, alongside a road that runs parallel to the road 230. The road 230 may be designated for one-way traffic moving westwards and the road that runs parallel to the road 230 may be designated for one-way traffic moving eastwards.

The second record generated by the law-enforcement vehicle 140 that is stationed (or moving) on the parallel road in the opposing arrangement, may be generated by the speeding violation responder system of the law-enforcement vehicle 140 by use of information obtained from one or more speed detection devices provided upon a front portion of the law-enforcement vehicle 140 and images captured by one or more image capture devices that may be mounted upon a front portion of the law-enforcement vehicle 140 (and/or a roof of the law-enforcement vehicle 140). In this case, the second record is generated with respect to the vehicle 215 that is traveling on the road 230. In another case, a third record in accordance with the disclosure can be generated with respect to a vehicle that is speeding eastwards on the road that runs parallel to the road 230. In this configuration, the law-enforcement vehicle 140 can detect and take action not only on vehicles moving eastwards but also assist in generating a record of a vehicle moving westwards and/or pursue the vehicle moving westwards.

In yet another example scenario the road 230 can be a multi-lane highway. In accordance with an embodiment of the disclosure, the law-enforcement vehicle 140 and the law-enforcement vehicle 105 may engage in a side-by-side pursuit arrangement by traveling on either side of the vehicle 215, such as, for example, on adjacent lanes of the multi-lane highway. The law-enforcement vehicle 105 can generate a first record and the law-enforcement vehicle 105 can generate a second record that may be used in court cases to complement evidence derived from the first record.

In at least some of the scenarios described above, a traffic ticket may be issued and/or a fine levied upon the driver 110 of the vehicle 105 based on detection of a speeding violation. In some cases, the traffic ticket and/or fine may be handed over to the driver 110 when the vehicle 105 reaches a toll-booth (when the road 230 is a toll road).

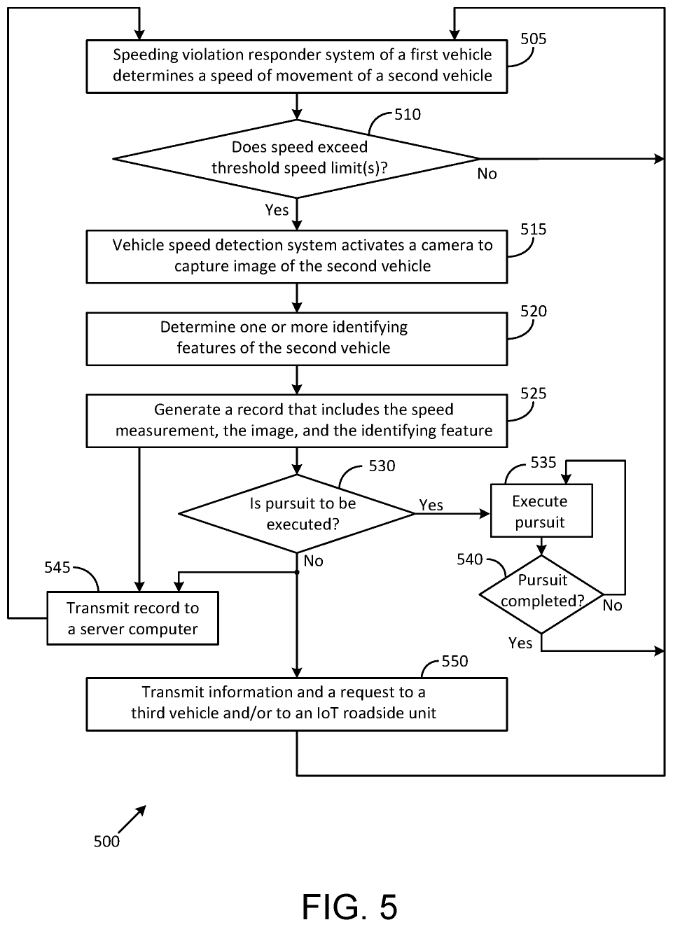

FIG. 5 shows a flowchart 500 of a method to detect a speeding violation in accordance with the disclosure. The flowchart 500 illustrates a sequence of operations that can be implemented in hardware, software, or a combination thereof. In the context of software, the operations represent computer-executable instructions stored on one or more non-transitory computer-readable media such as the memory 127, that, when executed by one or more processors such as the processor 126, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. The description below may make reference to certain components and objects shown in FIGS. 1 through 4, but it should be understood that this is done for purposes of explaining certain aspects of the disclosure and that the description is equally applicable to many other embodiments.

At block 505, a speeding violation responder system of a first vehicle, such as, for example, the speeding violation responder system 125 of the law-enforcement vehicle 105, may determine a speed of movement of a second vehicle such as, for example, the vehicle 215. The speed of the second vehicle may be determined by use of various types of detection devices provided in the first vehicle. In an example implementation, the speed of the second vehicle may be determined by operating one of a radar device or a LIDAR device such as, for example, the radar device 107 or the LIDAR device 106 of the law-enforcement vehicle 105. In another example implementation, the speed of the second vehicle may be determined by operating a radar device followed by operating a LIDAR device, such as, for example, operating the radar device 107 followed by operating the LIDAR device 106 of the law-enforcement vehicle 105. Determining the speed of the second vehicle by operating a radar device followed by operating a LIDAR device allows identification of the second vehicle committing the speeding violation when the second vehicle is moving among a group of vehicles and/or when a radar beam measurement is adversely affected by an intervening vehicle that may be located between the radar device and the second vehicle. Additional details pertaining to determining a speed of a vehicle by operating a radar device followed by a LIDAR device are provided above with reference to FIG. 2 wherein a vehicle 220 may adversely affect a speed measurement performed by the radar device 107 for determining a speed of movement of the vehicle 215.

At block 510, a determination is made whether the speed of the second vehicle exceeds one or more threshold speeds. In an example implementation a first speed measurement obtained by operating a radar device may be compared to a first threshold speed. The first threshold speed, which may be settable by a law-enforcement officer may for example, be equal to, or different than, a posted speed limit. In one case, the first threshold speed may be used to alert the law-enforcement officer of a speeding condition on a road being monitored by a speeding violation responder system of a law-enforcement vehicle in which the law-enforcement officer is seated. A LIDAR device may then be used to measure a speed of movement of the second vehicle and compare the speed of movement of the second vehicle against a second threshold speed. In one case, the second threshold speed may be set equal to the first threshold speed. In another case, the second threshold speed may be set to be different than the first threshold speed.

If the second vehicle is traveling below the threshold speed (below the second threshold speed, for example), the actions indicated in block 505 and block 510 are carried out.

If the second vehicle is traveling above the threshold speed (above the second threshold speed, for example), at block 515, an image capture device such as, for example, a camera of the image capture system 170 may be activated to capture an image that includes at least a portion of the second vehicle.

At block 520, one or more identifying features of the second vehicle may be determined by the speeding violation responder system (and/or the law-enforcement officer) based on evaluating one or more images captured by the image capture device. Some example identifying features can be a registration plate, a paint color, a damage (dent, missing part, etc.) and an accessory (ski rack, bicycle rack, spoiler etc.). In an example implementation, the speeding violation responder system may display one or more images of the second vehicle on a display screen of an infotainment system in the first vehicle and may seek the assistance of the law-enforcement officer to determine one or more identifying features of the second vehicle.

At block 525, the speeding violation responder system may generate a record that is associated with the second vehicle. In an example scenario, the record can include a speed measurement associated with the second vehicle, an image of the second vehicle, and one or more identifying features of the second vehicle. In some cases, the record may further include a first timestamp when a speed measurement of the second vehicle was captured, a second timestamp when the image of the vehicle was captured, and/or location information where the speeding violation occurred.

At block 530 a determination is made whether a pursuit operation is to be executed. If a pursuit operation is to be executed, at block 535 a pursuit of the second vehicle by the first vehicle is executed. In an example scenario, the pursuit is carried out by the first vehicle in an independent manner. In another example scenario, the pursuit is carried out in cooperation with a third vehicle (another law-enforcement vehicle, for example) using, for example, a tandem pursuit arrangement or an opposing arrangement. The tandem pursuit arrangement and the opposing arrangement are described above.

At block 540 a determination is made whether the pursuit has been completed. If the pursuit has been completed or has been discontinued, the actions indicated in block 505 and subsequent blocks may be carried out. If the pursuit has not been completed, execution of the pursuit (indicated at block 535) is continued.

If at block 530, a determination is made not to proceed with a pursuit operation, at block 550, information (such as, for example, a record associated with the second vehicle) may be transmitted by the speeding violation responder system of the first vehicle to a speeding violation responder system of a third vehicle and/or an IoT roadside unit. Some details pertaining to this operation are described above with respect to FIG. 3.

In at least some scenarios, at block 545, a record that is generated at block 525 may be transmitted to a server computer (such as, for example, the computer 160 described above). In some other scenarios, the record that is generated at block 525 may be transmitted to the server computer after a determination is made that a pursuit is not to be executed (block 530).

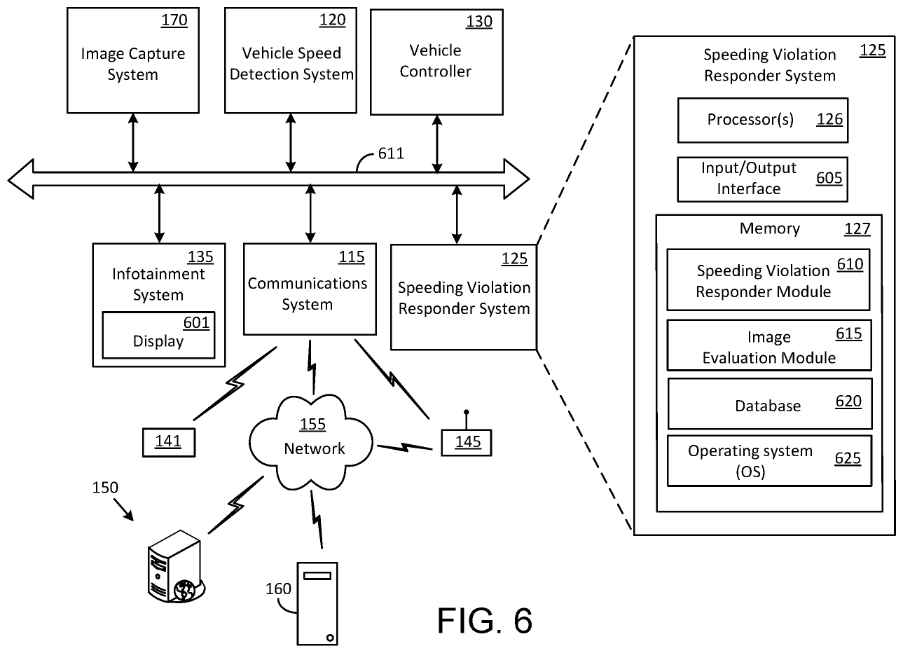

FIG. 6 shows some functional components that may be included in the example vehicle 105 in accordance with an embodiment of the disclosure. The example components can include the image capture system 170, the speed detection system 120, the vehicle controller 130, the infotainment system 135, the communications system 115, and the speeding violation responder system 125. The various components are communicatively coupled to each other via one or more buses such as an example bus 611. The bus 611 may be implemented using various wired and/or wireless technologies. For example, the bus 611 can be a vehicle bus that uses a controller area network (CAN) bus protocol, a Media Oriented Systems Transport (MOST) bus protocol, and/or a CAN flexible data (CAN-FD) bus protocol. Some or all portions of the bus 611 may also be implemented using wireless technologies such as Bluetooth®, Ultra-Wideband, Wi-Fi, Zigbee®, or near-field-communications (NFC). In an example implementation, a Matter protocol, which is a unifying, IP-based connectivity protocol may be used. The Matter protocol provides interoperability among various devices including artificial intelligence robots, drones, and Internet-of-Things (IoT) platforms.

The image capture system 170 can include various types of cameras such as, for example, the camera 108, the camera 117, and the camera 111 that are shown in FIG. 1.

The speed detection system 120 can include various types of speed detection devices such as, for example, the radar device 107, the radar device 113, the radar device 116, the LIDAR device 106, the LIDAR device 112, and the LIDAR device 114 that are shown in FIG. 1.

The vehicle controller 130 can be operated to execute various operations related to the vehicle 105, such as, for example, controlling engine operations (fuel injection, speed control, emissions control, braking, etc.), managing climate controls (air conditioning, heating etc.), activating airbags, and issuing alerts (check engine light, bulb issues, low tire pressure, etc.), and also for executing various operations in accordance with disclosure.

The infotainment system 135 can include a display system 601 having a GUI for carrying out various operations. The GUI may be used, for example, by the law-enforcement officer 110 to interact with the speeding violation responder system 125 and to execute actions associated with detecting speeding violations.

The communications system 115 can include various components such as, for example, a wireless transmitter, a wireless receiver, and/or a wireless transceiver, that are configured to allow the speeding violation responder system 125 to communicate with devices such as, for example, the computer 160, the cloud computer 150, the IoT roadside unit 145, and the example speeding violation responder system 141 (of the example vehicle 140), that are shown in FIG. 1). The communications may be carried out via wireless signals either directly or via the network 155 by use of any of various communication formats such as, for example, WiFi, cellular, TCP/IP, Bluetooth®, Ultra-Wideband, Wi-Fi, Ultra-Wideband (UBW), Zigbee®, and near-field-communications (NFC).

In one implementation, the speeding violation responder system 125 can be an independent device (enclosed in an enclosure, for example). In another implementation, some or all components of the speeding violation responder system 125 can be housed, merged, or can share functionality, with the vehicle controller 130. For example, an integrated unit that combines the functionality of the speeding violation responder system 125 with that of the vehicle controller 130 can be operated by a single processor and a single memory device. In the illustrated example configuration, the speeding violation responder system 125 includes the processor 126, an input/output interface 605, and the memory 127.

The input/output interface 605 is configured to provide communications between the speeding violation responder system 125 and other components such as the image capture system 170 (for obtaining captured images) and the speed detection system 120 (for obtaining speed measurements).

The memory 127, which is one example of a non-transitory computer-readable medium, may be used to store an operating system (OS) 625, a database 620, and various code modules such as a speeding violation responder module 610 and an image evaluation module 615. The code modules are provided in the form of computer-executable instructions that can be executed by the processor 126 for performing various operations in accordance with the disclosure.

The database 620 may be used to store information such as, for example, images captured by use of the cameras of the image capture system 170 and records of various traffic violations by one or more vehicles.

The speeding violation responder module 610 may be executed by the processor 126 for performing various operations in accordance with the disclosure, including, execution of some operations of the example flow chart 500 described above.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein. More particularly, it must be understood that various operations described above with respect to the speeding violation responder system 125 of the vehicle 105 can be executed by various other devices such as, for example, the computer 160 (and vice-versa). The computer 160 may execute these operations either independently, or in cooperation with the speeding violation responder system 125.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions, such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

A memory device, such as the memory 127, can include any one memory element or a combination of volatile memory elements (e.g., random access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, since the program can be electronically captured, for instance, via optical scanning of the paper or other medium, then compiled, interpreted or otherwise processed in a suitable manner if necessary, and then stored in a computer memory.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name, but not function.

It should be noted that the sensor embodiments discussed above may comprise computer hardware, software, firmware, or any combination thereof to perform at least a portion of their functions. For example, a sensor may include computer code configured to be executed in one or more processors and may include hardware logic/electrical circuitry controlled by the computer code. These example devices are provided herein for purposes of illustration and are not intended to be limiting. Embodiments of the present disclosure may be implemented in further types of devices, as would be known to persons skilled in the relevant art(s).

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described example embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a processor in a first vehicle, from a first vehicle speed detection system of the first vehicle, a speed measurement associated with a second vehicle;
determining, by the processor, based on evaluating the speed measurement, that a speed of the second vehicle exceeds a first threshold speed;
receiving, by the processor, from an image capture system of the first vehicle, an image comprising the second vehicle;
determining, by the processor, based on evaluating the image, at least a first identifying feature of the second vehicle; and
generating, by the processor, a record comprising the speed measurement, the image comprising the second vehicle, and the first identifying feature of the second vehicle.

2. The method of claim 1, wherein the first vehicle is a first law-enforcement vehicle and wherein the method further comprises:
transmitting, by the processor, at least a portion of the record to at least one of a server computer that is configured to store information associated with traffic violations, a second law-enforcement vehicle, or an internet-of-things (IoT) roadside unit that is configured to provide tracking of the second vehicle.

3. The method of claim 1, wherein the first vehicle is a first law-enforcement vehicle and wherein the method further comprises:
transmitting, by the processor, at least a portion of the record, to a second vehicle speed detection system of a second law-enforcement vehicle; and
transmitting, by the processor, a request to execute a pursuit operation of the second vehicle by the second law-enforcement vehicle based on the at least the portion of the record.

4. The method of claim 1, wherein the first vehicle is a first law-enforcement vehicle and wherein the method further comprises:
displaying, by the processor, on a display screen of an infotainment system of the first vehicle, a notification that includes at least one of the speed measurement associated with the second vehicle, the image comprising the second vehicle, or the first identifying feature of the second vehicle.

5. The method of claim 1, wherein the first threshold speed is equal to a posted speed limit, and wherein the method further comprises:
activating, by the processor, a radar device of the first vehicle speed detection system;
receiving, by the processor, from the radar device, a trigger signal indicating that at least one vehicle among a group of vehicles is traveling over a second threshold speed;
activating, by the processor, a light detection and ranging device of the first vehicle speed detection system; and
identifying, based on evaluating one or more speed measurements obtained from the light detection and ranging device, the second vehicle that is exceeding the second threshold speed.

6. The method of claim 5, wherein the second threshold speed is settable to be different than the posted speed limit.

7. The method of claim 5, wherein the first vehicle is a first law-enforcement vehicle and wherein the method further comprises:
generating, by the processor, an alert based on determining that the speed of the second vehicle exceeds the posted speed limit.

8. A method comprising:
determining, by a processor in a first vehicle, based on evaluating a speed measurement obtained from a first vehicle speed detection system of the first vehicle, that a second vehicle is traveling over a posted speed limit;
activating, by the processor, an image capture system of the first vehicle, to capture an image comprising the second vehicle; and
displaying, by the processor, on a display screen of an infotainment system of the first vehicle, a notification that includes at least one of the speed measurement associated with the second vehicle or the image comprising the second vehicle.

9. The method of claim 8, wherein the first vehicle is a first law-enforcement vehicle and wherein the method further comprises:
activating, by the processor, a radar device of the first vehicle speed detection system;
receiving, by the processor, from the radar device, a trigger signal indicating that at least one vehicle among a group of vehicles is traveling over a threshold speed;
activating, by the processor, a light detection and ranging device of the first vehicle speed detection system; and
identifying, based on evaluating one or more speed measurements obtained from the light detection and ranging device, the second vehicle that is exceeding the posted speed limit.

10. The method of claim 9, wherein the threshold speed is settable to be different than the posted speed limit.

11. The method of claim 8, wherein the first vehicle is a first law-enforcement vehicle and wherein the method further comprises:
determining, by the processor, based on evaluating the image, at least a first identifying feature of the second vehicle;
generating, by the processor, a record comprising the speed measurement, the image comprising the second vehicle, and the first identifying feature of the second vehicle; and
transmitting, by the processor, at least a portion of the record to at least one of a server computer that is configured to store information associated with traffic violations or an internet-of-things (IoT) roadside unit that is configured to provide tracking of the second vehicle.

12. The method of claim 8, wherein the first vehicle is a first law-enforcement vehicle and wherein the method further comprises:
transmitting, by the processor, to at least a computer of a third vehicle, an alert that the first law-enforcement vehicle is executing a pursuit operation.

13. The method of claim 8, wherein the first vehicle is a first law-enforcement vehicle and wherein the method further comprises:
identifying, by the processor, a traffic condition around the second vehicle, based one evaluating the image; and
displaying, by the processor, on the display screen of the infotainment system of the first vehicle, an advisory to one of pursue the second vehicle or desist from pursuing the second vehicle, based on the traffic condition.

14. The method of claim 13, further comprising:
transmitting, by the processor, to a second vehicle speed detection system of a second law-enforcement vehicle; the image comprising the second vehicle and the speed measurement; and
transmitting, by the processor, a request to execute a pursuit operation of the second vehicle by the second law-enforcement vehicle.

15. A vehicle comprising:
a vehicle speed detection system;
an image capture system; and
a speeding violation responder system comprising:
a memory that stores computer-executable instructions; and
a processor configured to access the memory and execute the computer-executable instructions to perform operations comprising:
receiving, from the vehicle speed detection system, a speed measurement associated with a second vehicle;
determining, based on evaluating the speed measurement, that a speed of the second vehicle exceeds a posted speed limit;
receiving, from the image capture system, an image that includes the second vehicle;
determining, based on evaluating the image, at least a first identifying feature of the second vehicle; and
generating, a record comprising the speed measurement, the image comprising the second vehicle, and the first identifying feature of the second vehicle.

16. The vehicle of claim 15, wherein the vehicle is a first law-enforcement vehicle, and wherein the processor is further configured to access the memory and execute the computer-executable instructions to perform operations comprising:
transmitting at least a portion of the record to at least one of a server computer that is configured to store information associated with traffic violations, a second law-enforcement vehicle, or an internet-of-things (IoT) roadside unit that is configured to provide tracking of the second vehicle.

17. The vehicle of claim 15, wherein the vehicle speed detection system comprises a radar device and a light detection and ranging device, and wherein the processor is further configured to access the memory and execute the computer-executable instructions to perform operations comprising:
activating the radar device;
receiving, from the radar device, a trigger signal indicating that at least one vehicle among a group of vehicles is traveling over a threshold speed;
activating the light detection and ranging device; and
identifying, based on evaluating one or more speed measurements obtained from the light detection and ranging device, the second vehicle that is exceeding the posted speed limit.

18. The vehicle of claim 17, wherein the threshold speed is settable to be different than the posted speed limit.

19. The vehicle of claim 15, further comprising an infotainment system comprising a display screen, and wherein the processor is further configured to access the memory and execute the computer-executable instructions to perform operations comprising:
displaying, on the display screen, a notification that includes at least one of the speed measurement associated with the second vehicle, the image comprising the second vehicle, or the first identifying feature of the second vehicle.

20. The vehicle of claim 15, further comprising an infotainment system comprising a display screen, and wherein the processor is further configured to access the memory and execute the computer-executable instructions to perform operations comprising:
generating an alert based on determining that the speed of the second vehicle exceeds the posted speed limit; and
displaying the alert on the display screen.
